(19) United States
(12) Patent Application Publication
(10) Pub. No.: US 2020/0157416 A1
(43) Pub. Date: May 21, 2020

(54) OIL-BASED FLUID COMPOSITIONS WITH ENHANCED ELECTRICAL CONDUCTIVITY

(71) Applicant: Baker Hughes, a GE company, LLC, Houston, TX (US)

(72) Inventors: Sankaran Murugesan, Katy, TX (US); Radhika Suresh, Sugar Land, TX (US); Valery Khabashesku, Houston, TX (US); Qusai Darugar, Houston, TX (US)

(73) Assignee: Baker Hughes, a GE company, LLC, Houston, TX (US)

(21) Appl. No.: 16/688,731

(22) Filed: Nov. 19, 2019

Related U.S. Application Data
(60) Provisional application No. 62/770,010, filed on Nov. 20, 2018.

(51) Int. Cl. C09K 8/82; C09K 8/03; C09K 8/60; C10L 1/12; E21B 47/00; E21B 49/00

(52) U.S. Cl. CPC C09K 8/82; C09K 8/032; C09K 8/602; B82Y 30/00; E21B 47/0002; E21B 49/00; C09K 2208/10; C10L 1/12

(57) ABSTRACT

Carbon quantum dots may be introduced into oil-based downhole fluids, such as drilling fluids, completion fluids, stimulation fluids, remediation fluids, and combinations thereof, or into distillate fuels, to increase their electrical conductivity and improve or maintain their performance in oil production and refining operations, in both low and high shear conditions.

### CROSS-REFERENCE TO RELATED APPLICATION

This application claims the benefit of Provisional Patent Application No. 62/770,010 filed Nov. 20, 2018, which is incorporated by reference herein in its entirety.

### TECHNICAL FIELD

The present invention relates oil-based fluid treatment, and more particularly relates to introducing carbon quantum dots to oil-based fluids to increase electrical conductivity of the fluids and methods of using such fluid compositions in oil production and refining operations.

### BACKGROUND

The present invention is directed to additives that may be introduced to oil-based fluids used in oil and gas production and refining operations to enhance their electrical conductivity.

Oil-based fluids or oil-based muds are preferred for drilling, reservoir/wellbore evaluation, and completion operations because of their usefulness in preserving shale stability, corrosion inhibition, lubricity, reusability, and resistance to contaminations and higher rate of penetration. Moreover, oil-based downhole fluids or muds are preferred in certain formation conditions, such as those with sensitive shales, or high pressure high temperature (HPHT) conditions where corrosion is abundant, or in high shear conditions.

In some oil and gas drilling operations, such as those involving the use of certain wellbore imaging tools, it is important to reduce the electrical resistivity (which is equivalent to increasing the electrical conductivity) of the oil-based downhole fluid as the electrical conductivity of the fluids has a direct impact on the image quality. Certain resistivity logging tools, such as high resolution LWD tool STARTRAK™ available from Baker Hughes, a GE company, require the fluid to be electrically conductive to obtain the best image resolution.

However, oil-based fluids are a challenge to use with high resolution resistivity tools, like STARTRAK™, because oil-based downhole fluids generally have a low electrical conductivity (i.e. high resistivity).

To address this challenge, a variety of different type of carbon-based nanoparticle materials have been added to oil-based downhole fluids. These materials include graphene nanoparticles, graphene platelets, graphene oxide, nanorods, nanoplatelets, nanotubes, carbon blacks, carbon nanofibers, and combinations thereof.

As shown in FIG. 1, one of the difficulties with using some of these carbon-based nanoparticles, graphene for example, is that, because of their size and shape, they lose their interconnectivity as the shear rate of the downhole fluid increases. This often results in a loss of electrical conductivity. To preserve interconnectivity and maintain electrical conductivity, more graphene or carbon content is added to the downhole fluid, which could lead to agglomeration and settlement of the particles and increase in the viscosity of the fluid. In addition, increasing the amount of materials in the fluids increases the cost of the operation.

In addition, oil-based refinery fluids may develop static charges that can pose a hazard in the processing and use of refinery distillates, such as diesel.

Rapid movement of hydrotreated fuel within a refinery or in transfer situations can generate static charges in the fuel. These static charges, if not allowed to dissipate by “resting” the fuel or bonding and grounding metallurgy in the system, could result in spark generation and explosions. The process of hydrotreating has been shown to decrease polar species content, which can increase the hazard because such charges are not as well dissipated. As a result, lesser hydrotreated fuels often contain sufficient polar components to allow static charges to dissipate throughout the fuel with minimum hazard. Conductivity additives have been employed to reduce this hazard by dissipating static charges throughout the fuel. Typical dose rates of such additives range from about 1 ppm and to about 5 ppm, depending on fuel response to achieve the 25-100 picosiemens per meter (“pS/m”) safety specification.

Thus, it would be desirable to increase the electrical conductivity of the oil-based or non-aqueous-liquid-based fluids to allow for better utilization these fluids in oil production and refining operations under various conditions.

### SUMMARY

There is provided, in one non-limiting form, a downhole fluid composition comprising an oil-based fluid and carbon quantum dots (“CQDs”), wherein the electrical conductivity of the downhole fluid composition ranges from about 0.01 ohm-m to about 1000 ohm-m and where the amount of carbon quantum dots is effective to increase the electrical conductivity of the downhole fluid composition to a level that is greater than the electrical conductivity of a fluid composition comprising an oil-based downhole fluid and no carbon quantum dots. The oil-based fluid may be a drilling fluid, a completion fluid, a production fluid, a stimulation fluid, and combinations thereof and the carbon quantum dots may range from about 10 nm in size to about 50 nm in size.

In another non-limiting form, the fluid composition above may be circulated into a subterranean reservoir wellbore and used to perform a procedure selected from the group consisting of well logging, drilling a well, completing a well, fracturing a formation, acidizing a formation, cementing a subterranean reservoir wellbore, altering the wettability of a formation surface, altering the wettability of a wellbore surface, and combinations thereof. In some embodiments, the shear rate of the circulated fluid composition within the subterranean reservoir wellbore ranges from about 0.01 s⁻¹ to about 5000 s⁻¹ and the electrical conductivity of the fluid composition having a shear rate from about 0.10 s⁻¹ to about 2000 s⁻¹ is the same or higher than the electrical conductivity of the same fluid composition having a shear rate lower than 1000 s⁻¹.

In another non-limiting embodiment, carbon quantum dots are added to a distillate fuel to enhance conductivity of the fuel and dissipate the static charges in the fuel, where the amount of carbon quantum dots is effective to increase the electrical conductivity of the fuel to a level that is greater than the electrical conductivity of a distillate fuel having no carbon quantum dots.

### BRIEF DESCRIPTION OF THE DRAWINGS

FIG. 1 is a graphic illustration of the behavior of graphene nanoparticles in downhole fluid having low shear and high shear and the impact of such behavior on electrical conductivity of the downhole fluid;

FIG. 2 is a graph comparing the frequency-dependent resistance measurements of a mineral oil sample with no carbon quantum dots (“CQDs”) and a sample of mineral oil containing CQDs;

FIG. 3 are a set of photographs depicting the device used (right) to determine the electrical conductivity of a sample of oil-based mud containing no carbon quantum dots and depicting the samples of oil-based mud containing carbon quantum dots and the samples of oil-based muds that were evaluated (left); and

FIG. 4 is a graph comparing the open circuit potential and current measurements of a sample of oil-based mud having no carbon quantum dots, a sample of oil-based mud containing carbon quantum dots, a sample of deionized water, and a sample of artificial sea water;

FIG. 5 is a photograph of a portable digital conductivity meter that may be used to measure electrical conductivity of a fuel.

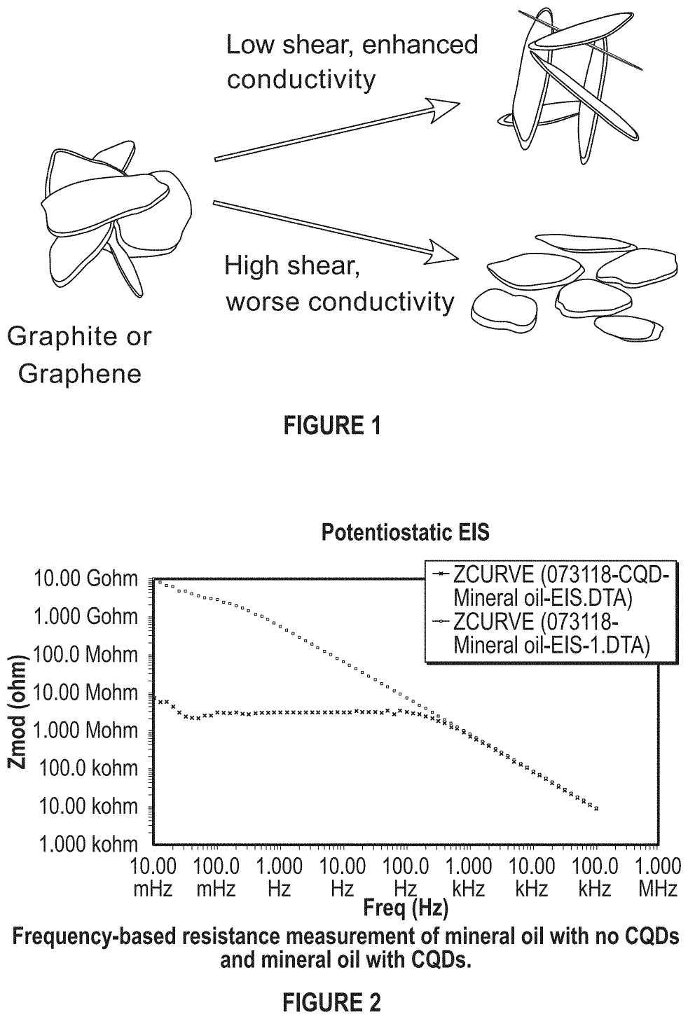

### DETAILED DESCRIPTION

It has been discovered that carbon quantum dots may be added to oil-based downhole fluids to increase or enhance the electrical conductivity of the oil-based downhole fluids and improve the performance of these fluids during drilling, formation evaluation, and other oil production operations. It has also been discovered that carbon quantum dots may be added to distillate fuels generated in a refining process to enhance conductivity of the fuel and dissipate the static charges in the fuel.

Carbon quantum dots have generated interest for use in oil production and refining operations, in part, for their ability to absorb and emit light and their solubility in fluids as compared to other carbonaceous materials, such as coke, graphene, graphene oxide, and carbon nanotubes.

As a result, much effort has been made to synthesize carbon quantum dots from various sources through either a top down or bottom up approach. In one non-limiting embodiment, these materials may be synthesized via the bottom up processes described in U.S. Pat. No. 9,715,036 B2, the disclosure of which is hereby incorporated by reference in its entirety.

In a non-limiting embodiment, the carbon quantum dots having the properties described above are introduced or added to an oil-based downhole fluid to increase or enhance the electrical conductivity of the oil-based downhole fluid. Upon the addition of the carbon quantum dots, the resulting fluid composition, may have an electrical conductivity ranging from about 0.01 ohm-m to about 1000 ohm-m, alternatively, from about 0.02 ohm-m to about 200 ohm-m, which is greater or higher than the electrical conductivity of a fluid composition comprising an oil-based downhole fluid absent the carbon quantum dots (i.e. containing no carbon quantum dots).

In one non-limiting embodiment, the carbon quantum dots useful in enhancing or increasing the electrical conductivity of oil-based downhole fluids of the types described further below are carbon nanoparticles having a size ranging from about 10 nm independently to about 50 nm independently; alternatively from about 5 nm independently to about 100 nm independently. It has been found that carbon quantum dots within this range of sizes exhibit good dispersion in the fluids. An increase in size could lead to agglomeration and settling of these nanoparticles and separation from the fluid. As used herein with respect to a range, “independently” means that any threshold may be used together with another threshold to give a suitable alternative range.

The amount of the carbon quantum dots necessary to increase the electrical conductivity of the oil-based downhole fluid to which they are added may vary depending on a number of factors, such as but not limited to, the depth within a wellbore, the temperature of the environment, the pressure of the environment, the size of the particles, and the like. In view of some of these factors, the amount of the carbon quantum dots within the fluid composition may range from about 0.01 wt % independently to about 10 wt % independently in one non-limiting embodiment; alternatively from about 0.001 wt % independently to about 25 wt % independently. Alternatively, the effective amount of the carbon quantum dots within the fluid composition may range from about 100 ppm to about 100,000 ppm.

The kinds of oil-based downhole fluids for which it would be beneficial to increase or enhance electrical conductivity include, without limitation, oil-based fluids used in drilling, completion, stimulation, and remediation of subterranean oil and gas wells.

Downhole fluids are typically classified according to their base fluid. In water-based fluids, solid particles are suspended in a continuous phase consisting of water or brine. Oil can be emulsified in the water, which is the continuous phase. “Water-based fluid” is used herein to include fluids having an aqueous continuous phase where the aqueous continuous phase can be all water or brine, an oil-in-water emulsion, or an oil-in-brine emulsion. Brine-based fluids, of course are water-based fluids, in which the aqueous component is brine.

Oil-based fluids are the opposite or inverse of water-based fluids. “Oil-based fluid” is used herein to include fluids having a non-aqueous continuous phase where the non-aqueous continuous phase is all oil, a non-aqueous fluid, a water-in-oil emulsion, a water-in-non-aqueous emulsion, a brine-in-oil emulsion, or a brine-in-non-aqueous emulsion. In oil-based fluids, solid particles are suspended in a continuous phase consisting of oil or another non-aqueous fluid. Water or brine can be emulsified in the oil; therefore, the oil is the continuous phase. In oil-based fluids, the oil may consist of any oil or water-immiscible fluid that may include, but is not limited to, diesel, mineral oil, esters, refinery cuts and blends, or alpha-olefins. Oil-based fluid as defined herein may also include synthetic-based fluids or muds (SBMs), which are synthetically produced rather than refined from naturally occurring materials. Synthetic-based fluids often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types.

Drilling fluids or drilling “muds” are fluids, gases, solids, and/or mixtures thereof used to aid in the drilling of boreholes into the earth for oil or gas production. The three main categories of drilling fluids are water-based muds (which can be dispersed and non-dispersed), non-aqueous muds, usually called oil-based mud, and gaseous drilling fluid, in which a wide range of gases can be used. The main functions of drilling fluids include providing hydrostatic pressure to prevent formation fluids from entering into the well bore, keeping the drill bit cool and clean during drilling, carrying out drill cuttings, and suspending the drill cuttings while drilling is paused and when the drilling assembly is brought in and out of the hole. The drilling fluid used for a particular job is selected to avoid formation damage and to limit corrosion.

There are a variety of functions and characteristics that are expected of completion fluids. The completion fluid may be placed in a well to facilitate final operations prior to initiation of production. Completion fluids are typically brines, such as chlorides, bromides, formates, but may be any non-damaging fluid having proper density and flow characteristics. Suitable salts for forming the brines include, but are not necessarily limited to, sodium chloride, calcium chloride, zinc chloride, potassium chloride, potassium bromide, sodium bromide, calcium bromide, zinc bromide, sodium formate, potassium formate, ammonium formate, cesium formate, and mixtures thereof. Chemical compatibility of the completion fluid with the reservoir formation and fluids is key. Chemical additives, such as polymers and surfactants are known in the art for being introduced to the brines used in well servicing fluids for various reasons that include, but are not limited to, increasing viscosity, and increasing the density of the brine. Water-thickening polymers serve to increase the viscosity of the brines and thus retard the migration of the brines into the formation and lift drilled solids from the wellbore. A regular drilling fluid is usually not compatible for completion operations because of its solid content, pH, and ionic composition. Completion fluids also help place certain completion-related equipment, such as gravel packs, without damaging the producing subterranean formation zones. Modifying the electrical conductivity and resistivity of completion fluids may allow the use of resistivity logging tools for facilitating final operations.

A stimulation fluid may be a treatment fluid prepared to stimulate, restore, or enhance the productivity of a well, such as fracturing fluids and/or matrix stimulation fluids in one non-limiting example. Suitable types of stimulation fluids include, but are not necessarily limited to, those containing one or more acids, fracturing fluids, and combinations of these.

Servicing fluids, such as remediation fluids, workover fluids, and the like, have several functions and characteristics necessary for repairing a damaged well. Such fluids may be used for breaking emulsions already formed and for removing formation damage that may have occurred during the drilling, completion and/or production operations. The terms “remedial operations” and “remediate” are defined herein to include a lowering of the viscosity of gel damage and/or the partial or complete removal of damage of any type from a subterranean formation. Similarly, the term “remediation fluid” is defined herein to include any fluid that may be useful in remedial operations. These servicing fluids aid in balancing the pressure of the reservoir and prevent the influx of any reservoir fluids. Tools typically used for remedial operations include wireline tools, packers, perforating guns, flow-rate sensors, electric logging sondes, etc.

The fluid composition made up of one or more of these oil-based fluids and carbon quantum dots having an increased or enhanced electrical conductivity may be circulated into a subterranean reservoir wellbore, and a downhole tool may be operated with the fluid composition at the same time or different time as the circulating of the fluid composition. In a non-limiting embodiment, the fluid composition may be circulated into a formation comprising a substance, such as but not limited to, cement, lime, carbonates, and combinations thereof. Alternatively, the fluid composition includes a drilling fluid as the downhole fluid, and the drilling fluid is used to drill into a formation comprising a substance, such as but not limited to, cement, lime, carbonates, and combinations thereof.

In another non-limiting embodiment, the addition of the carbon quantum dots may preserve or maintain or even improve the amount or level of electrical conductivity of the oil-based downhole fluid(s) to which the carbon quantum dots are introduced regardless of the shear rate of the fluid composition within the subterranean reservoir wellbore. In other words, the electrical conductivity of the fluid composition comprising an oil-based downhole fluid and carbon quantum dots having a shear rate from about 0.1 s⁻¹ to about 2000 s⁻¹ may be the same or higher than the electrical conductivity of the same fluid composition having a shear rate lower than 1000 s⁻¹. As shown in the FIG. 2, a sample of a mixture of mineral oil and CQDs maintains a steady and lower electrical resistance than a sample of mineral oil alone even as frequencies of the samples increase.

After circulating the fluid composition, the method may also include performing a procedure selected from the group consisting of well logging, drilling a well, completing a well, fracturing a formation, acidizing a formation, cementing a subterranean reservoir wellbore, altering the wettability of a formation surface, altering the wettability of a wellbore surface, and combinations thereof. A downhole tool give improved images as compared to a downhole tool being operated at the same time or different time as a fluid composition absent the carbon black particles and/or optional additional particle(s). Enhanced electrical conductivity of the fluid composition may form an electrically conductive filter cake that highly improves real time high resolution logging processes, as compared with an otherwise identical fluid absent the carbon black particles and/or optional additional particle(s).

In another non-limiting embodiment, the fluid composition may include a surfactant in an amount effective to suspend the carbon quantum dots or other particles in the downhole fluid. The surfactant may be present in the fluid composition in an amount ranging from about 1 vol % independently to about 10 vol % independently, or from about 2 vol % independently to about 8 vol % independently in another non-limiting embodiment.

Expected suitable surfactants may include, but are not necessarily limited to non-ionic, anionic, cationic, zwitterionic surfactants, janus surfactants, and combinations thereof. Suitable nonionic surfactants may include, but are not necessarily limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both. Suitable anionic surfactants may include alkali metal alkyl sulfates, alkyl ether sulfonates, alkyl sulfonates, alkyl aryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, and phosphate esters. Suitable cationic surfactants may include, but are not necessarily limited to, arginine methyl esters, alkanolamines and alkylenediamides. Suitable surfactants may also include surfactants containing a non-ionic spacer-arm central extension, and an ionic or nonionic polar group. Other suitable surfactants may be dimeric or gemini surfactants, cleavable surfactants, janus surfactants and extended surfactants, also called extended chain surfactants.

In a further non-limiting embodiment, the carbon quantum dots having one or more of the properties described above may be introduced or added to a distillate fuel to increase or enhance the electrical conductivity of the fuel and dissipate the static charges in the fuel. The ability of a distillate fuel to dissipate charge that may have been generated during pumping and filtering operations may be controlled by the level of the fuel's electrical conductivity. If the electrical conductivity is sufficiently high, charges may dissipate fast enough to prevent their accumulation and avoid the dangerously high potentials in a receiving tank. Distillate fuels to which carbon quantum dots may be added for this purpose, include but are not limited to, diesel fuel, fuel oil, a fuel containing kerosene, and combinations thereof. Upon the addition of the carbon quantum dots, the resulting fuel composition has an electrical conductivity that is greater or higher than the electrical conductivity of a fuel composition comprising a distillate fuel and no carbon quantum dots. The increase in electrical conductivity of the fuel by the addition or introduction of carbon quantum dots aids in dissipating the static charge within the distillate fuel, thus reducing the hazards associated with fuel with a buildup of static charge.

The invention will be further described with respect to the following Example(s), which are not meant to limit the invention, but rather to further illustrate the various embodiments.

### Example 1

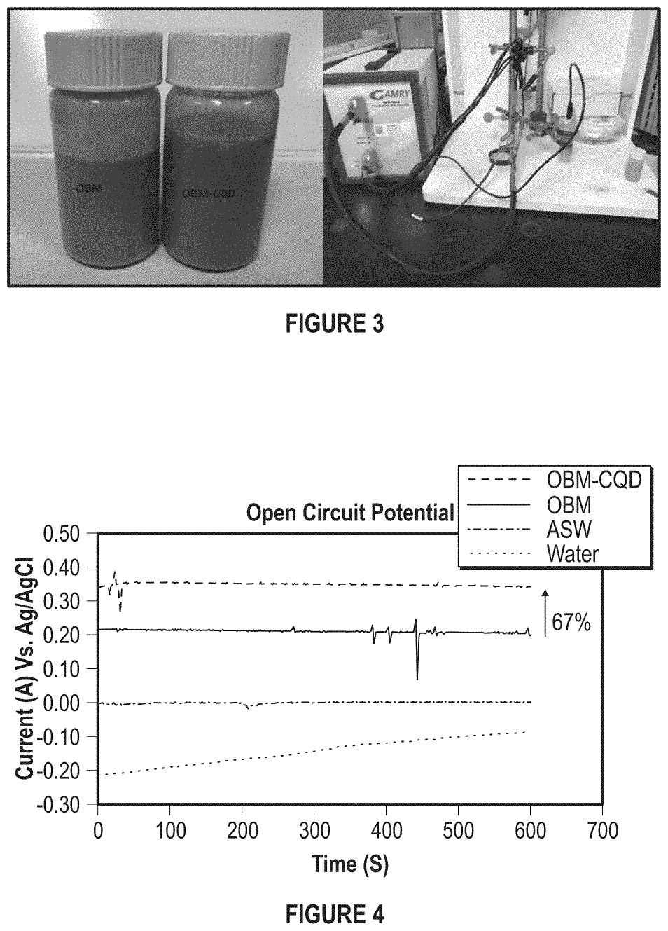

The performance of oil-soluble carbon quantum dots in enhancing the electrical conductivity of a Baker Hughes Oil-Based Drilling Mud (OBM) were evaluated, as shown in FIG. 3, using screen printed and carbon electrodes to determine the change in conductivity through open circuit potential (OCP) measurements of a sample of Baker Hughes Drilling OBM containing carbon quantum dots and a sample of Baker Hughes Drilling OBM containing no carbon quantum dots. The open circuit potential of samples of deionized water and Artificial Sea Water (ASW) was also measured as additional points of comparison.

The graph in FIG. 4 shows that the OCP measurements reflecting changes in conductivity of each sample shows that there was a 67% increase in OCP between the sample of Drilling OBM containing the carbon quantum dots and the Drilling OBM without any carbon quantum dots. This data indicates that the increase in the potential may be attributed to the presences of carbon quantum dots in the oil-based drilling fluid.

### Example 2

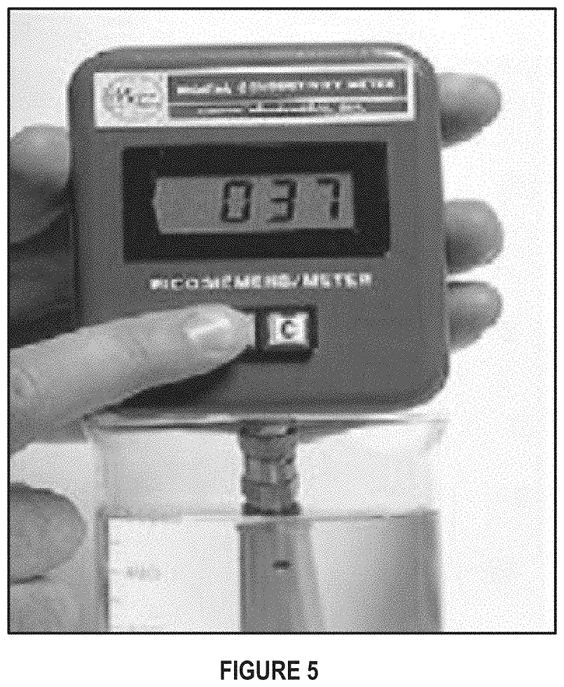

A portable voltage meter of the kind depicted in FIG. 5 was used to measure the electrical conductivity of diesel fuel having no carbon quantum dots and varying amounts of carbon quantum dots to see how much the application of carbon quantum dots increased electrical conductivity, which is associate with the dissipation of static charge in the fuel. The portable voltage meter reads the conductivity value of the fuel based on the current generated after a voltage is applied across two electrodes in the fuel. The portability of the meter allows for the measurement to be made almost instantaneously upon application of the voltage to avoid error due to ion depletion. A portable meter may measure electrical conductivity of a fuel at rest and is suitable for measuring fuel electrical conductivity value between 1 and 2000 picosiemens per meter (“pS/m”).

Table 1 shows the electrical conductivity measurements taken by the portable voltage meter shown in FIG. 5 of various samples of diesel fuel having no carbon quantum dots and increasing amounts of carbon quantum dots.

TABLE 1
Conductivity of ultra-low sulfur diesel
with various doses of carbon quantum dots

| Sample | Additive | Dose, ppm | Conductivity (pS/m) |
|---|---|---|---|
| Diesel | Blank | 0 | 0 |
| Diesel | CQD | 10 | 6 |
| Diesel | CQD | 25 | 22 |
| Diesel | CQD | 50 | 53 |
| Diesel | CQD | 100 | 124 |

The data in Table 1 shows that an increase in the amount of carbon quantum dots added to the diesel fuel results in significant increases in electrical conductivity, which may correlate to enhanced reduction in the electrostatic hazards of the diesel fuel.

In the foregoing specification, the invention has been described with reference to specific embodiments thereof. However, it will be evident that various modifications and changes can be made thereto without departing from the broader spirit or scope of the invention as set forth in the appended claims. Accordingly, the specification is to be regarded in an illustrative rather than a restrictive sense. For example, oil-based fluids, fuels, carbon nanomaterials, surfactants, amounts, concentrations, electrical conductivity values, carbon quantum dot sizes, and shear rates not specifically identified or disclosed herein are still expected to be within the scope of this invention.

The present invention may suitably comprise, consist or consist essentially of the elements disclosed and may be practiced in the absence of an element not disclosed.

For example, the methods may consist of or consist essentially of adding or introducing carbon quantum dots to an oil-based downhole fluid or may consist of or consist essentially of adding or introducing carbon quantum dots to a distillate fuel.

In another non-limiting embodiment, the fluid composition may comprise, consist essentially of, or consist of an oil-based downhole fluid and carbon quantum dots or may comprise, consist essentially of, or consist of a distillate fuel and carbon quantum dots.

As used herein, the singular forms “a,” “an,” and “the” are intended to include the plural forms as well, unless the context clearly indicates otherwise.

As used herein, the term “about” in reference to a given parameter is inclusive of the stated value and has the meaning dictated by the context (e.g., it includes the degree of error associated with measurement of the given parameter).

As used herein, the term “and/or” includes any and all combinations of one or more of the associated listed items.

What is claimed is:

1. A downhole fluid composition comprising:
an oil-based fluid; and
carbon quantum dots,
wherein the electrical conductivity of the downhole fluid composition ranges from about 0.01 ohm-m to about 1000 ohm-m, and where the amount of carbon dots is effective to increase the electrical conductivity to a level that is greater than the electrical conductivity of a fluid composition comprising an oil-based downhole fluid absent the carbon quantum dots.

2. The downhole fluid composition of claim 1, wherein the effective amount of the carbon quantum dots within the fluid composition ranges from about 0.001 wt % to about 25 wt %.

3. The downhole fluid composition of claim 1, wherein the effective amount of the carbon quantum dots within the fluid composition ranges from about 100 ppm to about 100,000 ppm.

4. The downhole fluid composition of claim 1, wherein the carbon quantum dots have a particle size ranging from about 10 nm to about 50 nm.

5. The downhole fluid composition of claim 1, wherein the downhole fluid composition is selected from a group consisting of a drilling fluid, a completion fluid, a stimulation fluid, a remediation fluid, and combinations thereof.

6. The downhole fluid composition of claim 1 further comprising at least one surfactant.

7. The downhole fluid composition of claim 6, wherein the at least one surfactant is selected from a group consisting of non-ionic surfactants, anionic surfactants, cationic surfactants, amphoteric surfactants, janus surfactants, and combinations thereof.

8. A method comprising:
adding carbon quantum dots to an oil-based fluid composition; and
increasing the electrical conductivity of the downhole fluid to a level that is higher than an oil-based downhole fluid having no carbon quantum dots.
circulating the downhole fluid containing carbon quantum dots into a subterranean reservoir wellbore.

9. The method of claim 8, further comprising the step of performing a procedure selected from the group consisting of well logging, drilling a well, completing a well, fracturing a formation, acidizing a formation, cementing a subterranean reservoir wellbore, altering the wettability of a formation surface, altering the wettability of a wellbore surface, and combinations thereof.

10. The method of claim 8, wherein the amount of the carbon quantum dots within the fluid composition ranges from about 0.01 wt % to about 10 wt %.

11. The method of claim 8, wherein the carbon quantum dots have a particle size ranging from about 5 nm to about 100 nm.

12. The method of claim 8, wherein the downhole fluid is selected from a group consisting of a drilling fluid, a completion fluid, a stimulation fluid, a remediation fluid, and combinations thereof.

13. The method of claim 12, wherein the at least one surfactant is selected from a group consisting of non-ionic surfactants, anionic surfactants, cationic surfactants, amphoteric surfactants, janus surfactants, and combinations thereof.

14. A method comprising:
circulating a downhole fluid composition into a subterranean reservoir wellbore, wherein the downhole fluid composition comprises an oil-based fluid and carbon quantum dots having a particle size ranging from about 10 nm to about 50 nm.

15. The method of claim 14, wherein the shear rate of the downhole fluid composition within the subterranean reservoir wellbore ranges from about 0.01 s⁻¹ to about 5000 s⁻¹.

16. The method of claim 15, wherein the electrical conductivity of the downhole fluid composition having a shear rate from about 0.10 s⁻¹ to about 2000 s⁻¹ is the same or higher than the electrical conductivity of the same fluid composition having a shear rate lower than 1000 s⁻¹.

17. The method of claim 14, wherein the amount of the carbon quantum dots within the downhole fluid composition ranges from about 100 ppm to about 100,000 ppm.

18. A method comprising:
adding carbon quantum dots to a distillate fuel; and
increasing the electrical conductivity of the distillate fuel to a level that is higher than a distillate fuel having no carbon quantum dots and dissipating static charge in the fuel.

19. The method of claim 18, wherein the distillate fuel is selected from a group consisting of diesel fuel, fuel oil, a fuel containing kerosene, and combinations thereof.

20. A treated fuel composition comprising:
a distillate fuel; and
carbon quantum dots,
wherein the amount of carbon dots is effective to increase the electrical conductivity to a level that is greater than the electrical conductivity of a treated fuel composition comprising a distillate fuel and no carbon quantum dots.
